(19) United States
(12) Patent Application Publication
(10) Pub. No.: US 2006/0036040 A1
(43) Pub. Date: Feb. 16, 2006

(54) Adhesive

(75) Inventors: Ryu Takeko, Ashiya-shi (JP); Akira Kawamura, Izumisano-shi (JP); Seung Kil Han, Pyeongtaek-si (KR)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/198,329

(22) Filed: Aug. 8, 2005

(30) Foreign Application Priority Data
Aug. 11, 2004 (JP) 2004-234283
Jan. 5, 2005 (JP) 2005-000530

(51) Int. Cl. C08F 8/00

(52) U.S. Cl. 525/192

(57) ABSTRACT

An adhesive obtained by compounding a cross-linking agent to an acrylic resin composition comprising a silane-based compound and the following acrylic resins (1) and (2), wherein the content of acrylic resin (1) is 10 to 50 parts by weight based on 100 parts by weight of the total amount of the acrylic resin (1) and acrylic resin (2); acrylic resin (1): an acrylic resin having a molecular weight of 50,000 to 500,000 and containing a structural unit derived from a monomer (a) (structural unit (a)); acrylic resin (2): an acrylic resin having a molecular weight of 1,000,000 to 1,500,000 and a molecular weight distribution (Mw/Mn) of 5 or less, and containing the structural unit (a) as the main component and a structural unit derived from a monomer (b) (structural unit (b));
(a): a (meth)acrylate of the formula (A) 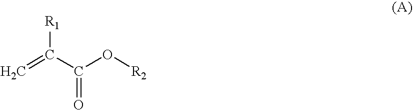 (b): a monomer containing one olefinic double bond and at least one polar functional group selected from the group consisting of a carboxyl group, hydroxyl group, amide group, amino group, epoxy group, oxetanyl group, aldehyde group and isocyanate group in the molecule.

### BACKGROUND OF THE INVENTION

1. Technical Field of the Invention

The present invention relates to an adhesive.

2. Description of the Related Art

Liquid crystal cells generally used in liquid crystal displays such as a TN liquid crystal cell (TFT), a STN liquid crystal cell (STN) and the like, have a structure in which a liquid crystal component is sandwiched between two glass base materials. On the surface of the glass base material, an optical film such as a polarizing film, phase retardation film and the like is laminated via an adhesive composed mainly of an acrylic resin. An optical laminate composed of a glass base material, adhesive and optical film laminated in this order is in general produced by a method in which first an optical laminated film having an adhesive layer composed of an adhesive laminated on an optical film is obtained, and then, a glass base material is laminated on the surface of the adhesive layer.

Such an optical laminated film tends to generate curl and the like due to large dimension change by expansion and shrinkage under heating or moistening and heating conditions, consequently, there are problems such as occurrence of foaming in an adhesive layer of the resulted optical laminate, generation of peeling between an adhesive layer and a glass base material, and the like. Under heating or moistening and heating conditions, distribution of remaining stress acting on an optical laminated film becomes non-uniform, concentration of stress occurs around peripheral parts of an optical laminate, consequently, there is a problem that light leakage occurs in a TN liquid crystal cell (TFT).

Further, recently, such a liquid display is used for vehicle-mounted applications such as a car navigation system and the like, however, in vehicle-mounted applications, durability such as no occurrence of appearance change such as foaming, floating, peeling, fogging and the like is also being required.

For solving such problems, there is a suggestion on an adhesive mainly composed of a high molecular weight acrylic resin having a weight average molecular weight of 600,000 to 2,000,000 and a low molecular weight acrylic resin having a weight average molecular weight of 500,000 or less (see, Japanese Patent Application Laid-Open (JP-A) No. 2000-109771, claim 1).

However, there is a problem that an optical laminate obtained by laminating an optical film with an adhesive mainly composed of an acrylic resin having a weight average molecular weight of 100,000 and an acrylic resin having a weight average molecular weight of 1,050,000 is poor in durability due to a generation of a peeling or fogging on the surface of the glass base plate when the optical laminate is subjected to 100 cycles of 60° C.→−20° C.→60° C. procedure.

The present inventors have investigated an adhesive having almost no problems described above and found that an adhesive obtained by using an acrylic resin composition containing a kind of an acrylic resin in some extent gives a optical laminate which light leakage is suppressed and durability is excellent.

### DISCLOSURE OF THE INVENTION

An object of the present invention is to provide an adhesive capable of producing an optical laminate in which light leakage is suppressed and durability is improved.

Namely, the present invention provides the following [1] to [11].
[1] An adhesive obtained by compounding a cross-linking agent to an acrylic resin composition comprising a silane-based compound and the following acrylic resins (1) and (2), wherein the content of acrylic resin (1) is 10 to 50 parts by weight based on 100 parts by weight of the total amount of the acrylic resin (1) and acrylic resin (2);
   acrylic resin (1): an acrylic resin having a molecular weight of 50,000 to 500,000 and containing a structural unit derived from a monomer (a) (structural unit (a));
   acrylic resin (2): an acrylic resin having a molecular weight of 1,000,000 to 1,500,000 and a molecular weight distribution (Mw/Mn) of 5 or less, and containing the structural unit (a) as the main component and a structural unit derived from a monomer (b) (structural unit (b));
   (a): a (meth)acrylate of the formula (A) 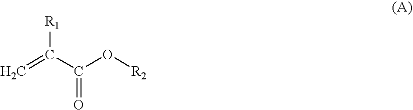
      (wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.),
   (b): a monomer containing one olefinic double bond and at least one polar functional group selected from the group consisting of a carboxyl group, hydroxyl group, amide group, amino group, epoxy group, oxetanyl group, aldehyde group and isocyanate group in the molecule.
[2] The adhesive according to [1], wherein the glass transition temperature (Tg) of the acrylic resin (1) is from −30° C. to −5° C.
[3] The adhesive according to [1] or [2], wherein the acrylic resin (1) further contains the structural unit (b).
[4] The adhesive according to any one of [1]-[3], wherein the content of the structural unit (b) in the acrylic resin (2) is from 0.5 to 2 parts by weight based on 100 parts by weight of the acrylic resin (2).
[5] An optical laminated film laminating an adhesive layer composed of the adhesive according to any one of [1] to [4] on both surfaces or one surface of an optical film.
[6] The optical laminated film according to [5], wherein the optical film is a polarizing film and/or phase retardation film.
[7] The optical laminated film according to [5] or [6], wherein the optical film further has an acetylcellulose-based film as a release film.
[8] The optical laminated film according to any one of [5]-[7], wherein a release film is further laminated on the adhesive layer of the optical laminated film.
[9] An optical laminate obtained by laminating a glass base material on the adhesive layer of the optical laminated film according to any one of [5]-[7].
[10] An optical laminate obtained by peeling the release film from the optical laminated film according to [8], then, laminating a glass base material on the adhesive layer of the optical laminated film.
[11] An optical laminate obtained by peeling the optical laminated film from the optical laminate according to [9] or [10], then, laminating again the optical laminated film on the resulted glass base material.

The present invention will be described in detail below.

The monomer (a) used in the acrylic resin (1) and the acrylic resin (2) is a (meth)acrylate of the following formula (A):

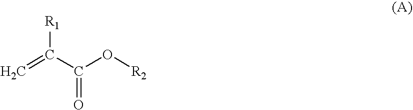

In the formula, R₁ represents a hydrogen atom or methyl group, R₂ represents an alkyl group having 1 to 14 carbon atoms or an aralkyl group having 1 to 14 carbon atoms. A hydrogen atom in the alkyl group R₂ or a hydrogen atom in the aralkyl group R₂ may be substituted with an alkoxy group having 1 to 10 carbon atoms.

Examples of the alkyl group having 1 to 14 carbon atoms include a methyl group, ethyl group, butyl group, octyl group, and the like.

Examples of the aralkyl group having 1 to 14 carbon atoms include a benzyl group, and the like. The aralkyl group having 7 to 14 carbon atoms is preferably used.

Examples of the alkoxy group having 1 to 10 carbon atoms include a methoxy group, ethoxy group, butoxy group and the like.

Examples of the monomer (a) include acrylates such as methyl acrylate, ethyl acrylate, propyl acrylate, n-butyl acrylate, iso-butyl acrylate, 2-ethylhexyl acrylate, n-octyl acrylate, iso-octyl acrylate, lauryl acrylate, stearyl acrylate, cyclohexyl acrylate, isobornyl acrylate, benzyl acrylate, methoxyethyl acrylate, ethoxylmethyl acrylate and the like; and
methacrylates such as methyl methacrylate, ethyl methacrylate, propyl methacrylate, n-butyl methacrylate, iso-butyl methacrylate, 2-ethylhexyl methacrylate, n-octyl methacrylate, iso-octyl methacrylate, lauryl methacrylate, stearyl methacrylate, cyclohexyl methacrylate, isobornyl methacrylate, benzyl methacrylate, methoxyethyl methacrylate, ethoxymethyl methacrylate and the like.

The monomer (a) may be used alone or in admixture of two or more.

The content of a structural unit derived from the monomer (a) (structural unit (a)) in the acrylic resin (1) is usually from approximately 60 to 99.9 parts by weight, and preferably from approximately 70 to 99.5 parts by weight based on 100 parts by weight of the acrylic resin (1).

The content of a structural unit derived from the monomer (a) (structural unit (a)) in the acrylic resin (2) is usually from approximately 70 to 99.9 parts by weight, and preferably from approximately 90 to 99.6 parts by weight based on 100 parts by weight of the acrylic resin (2).

The structural unit derived from the monomer (b) (structural unit (b)) is an essential component of the acrylic resin (2) and may contain in the acrylic resin (1) as a arbitrary component.

Here, the monomer (b) is a monomer containing one olefinic double bond and at least one polar functional group selected from the group consisting of a carboxyl group, hydroxyl group, amino group, amide group, epoxy group, oxetanyl group, aldehyde group and isocyanate group in the molecule.

Examples of the monomer (b) in which the polar functional group is a carboxyl group include α,β-unsaturated carboxylic acids such as acrylic acid, methacrylic acid, maleic acid, itaconic acid and the like;
in which the polar functional group is a hydroxyl group include hydroxyalkyl α,β-unsaturated carboxylates such as 2-hydroxyethyl (meth)acrylate, 2-hydroxypropyl_ (meth)acrylate, 4-hydroxybutyl (meth)acrylate and the like;
in which the polar functional group is an amino group include N,N-dimethylaminoethyl acrylate, allylamine and the like;
in which the polar functional group is an amide group include acrylamide, methacrylamide, N,N-dimethylaminopropylacrylamide, diacetonediamide, N,N-dimethylacrylamide, N,N-diethylacrylamide, N-methylolacrylamide and the like;
in which the polar functional group is an epoxy group include glycidyl acrylate, glycidyl methacrylate and the like;
in which a polar functional group is an oxetany group such as oxetanyl (meth)acrylate, 3-oxetanylmethyl (meth)acrylate, (3-methyl-3-oxetanyl)methyl (meth)acrylate, (3-ethyl-3-oxetanyl)methyl (meth)acrylate and the like;
in which a polar functional group is an aldehyde group such as acrylaldehyde and the like;
in which a polar functional group is an isocyanate group such as 2-methacryloyloxyethyl isocyanate and the like.

Here, a monomer having 7-membered heterocyclic group such as 3,4-epoxycyclohexyl methyl acrylate, 3,4-epoxycyclohexyl methyl methacrylate can be used as the monomer (b).

The monomer (b) may be used alone or in admixture of two or more.

However, when using monomers (b) having functional groups reacted each other such as a monomer (b) having an isocyanate group and a monomer (b) having at least one functional group selected from the group consisting of a hydroxyl group, amino group and epoxy group at the same time, there may occur gel during polymerization of the acrylic resin.

As the monomer (b), (meth)acrylic acid, 2-hydroxyethyl (meth)acrylate, 4-hydroxybuthyl (meth)acrylate are preferable due to easy availability.

The content of a structural unit derived from the monomer (b) (structural unit (b)) contained in the acrylic resin (2) is usually from approximately 0.5 to 2 parts by weight, and preferably from approximately 0.5 to 1.5 parts by weight based on 100 parts by weight of the acrylic resin (2). When the content of the structural unit (b) is 0.5 part by weight or more, the cohesive force of the resulting resin tends to increase preferably, when the content of the structural unit (b) is 2 parts by weight or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

When using a monomer (b) in the acrylic resin (1), the content of a structural unit derived from the monomer (b) (structural unit (b)) contained in the acrylic resin (1) is usually from approximately 0 to 20 parts by weight based on 100 parts by weight of the acrylic resin (1). When the content of the structural unit (b) is 20 parts by weight or less, floating and peeling between a glass base plate and an adhesive layer tends to be suppressed preferably.

In the adhesive of the present invention, the functional group contained in the structural unit (b) and a cross-linking agent are reacted to be gel. Therefore, in order to increase gel fraction, the content of the structural unit (b) may be increased preferably.

In producing the acrylic resin (1) and the acrylic resin (2) of the present invention, a monomer (c) having one olefinic double bond and 5- or more-membered cyclic structure in the molecule may be polymerized with the monomers (a) and (b).

As the monomer (c), a monomer having one olefinic double bond and alicyclic structure in the molecule (alicyclic monomer), a monomer having one olefinic double bond and heterocyclic structure in the molecule (heterocyclic monomer) and the like are exemplified.

The alicyclic structure in the alicyclic monomer is usually a cycloparaffin structure or cycloolefin structure having 5 or more carbon atoms, preferably approximately 5 to 7 carbon atoms, and in the cycloolefin structure, an olefinic double bond is contained in the alicyclic structure.

Examples of the monomer having one olefinic double bond and alicyclic structure (alicyclic monomer) include the acrylate having an alicyclic structure such as isobornyl acrylate, cyclohexyl acrylate, dicyclopentanyl acrylate, cyclododecyl acrylate, methylcyclohexyl acrylate, trimethylcyclohexyl acrylate, tert-butylcyclohexyl acrylate, cyclohexyl-α-ethoxy acrylate, cyclohexyl phenyl acrylate and the like;
methacrylate having an alicyclic structure such as isobornyl methacrylate, cyclohexyl methacrylate, dicyclopentanyl methacrylate, cyclododecyl methacrylate, methylcyclohexyl methacrylate, trimethylcyclohexyl methacrylate, tert-butylcyclohexyl methacrylate, cyclohexyl-α-ethoxy methacrylate, cyclohexyl phenyl methacrylate and the like.

As the alicyclic monomer, isobornyl acrylate, cyclohexyl acrylate, isobornyl methacrylate, cyclohexyl methacrylate, dicyclopentanyl acrylate are preferable due to easy availability.

As the acrylate having a plurality of alicyclic structures, biscyclohexyl methyl itaconate, dicyclooctyl itaconate, dicyclododecyl methyl succinate and the like are exemplified.

Vinyl cyclohexyl acetate containing vinyl group and the like can be used as the monomer (c).

The heterocyclic structure in the heterocyclic monomer is usually the structure in which a carbon atom of at least one methylene group in an alicyclic hydrocarbon group having 5 or more carbon atoms, preferably 5 to 7 carbon atoms is substituted with a hetero atom such as a nitrogen atom, oxygen atom or sulfur atom.

Specific examples of the heterocyclic monomer include acryloylmorpholine, vinylcaprolactam, N-vinyl-2-pyrrolidone, tetrahydrofurfuryl acrylate, tetrahydrofurfuryl methacrylate, caprolactone-modified tetrahydrofurfuryl acrylate and the like.

Monomers having an olefinic double bond contained in a heterocyclic group, such as 2,5-dihydrofuran and the like are included in the monomer (c).

Among them, N-vinylpyrrolidone, vinylcaprolactam, acryloylmorpholine, or mixtures thereof are suitably used, N-vinylpyrrolidone, vinylcaprolactam are more suitably used.

The monomer (c) may be used alone or in combination of two or more.

The content of the structural unit derived from monomer (c) (structural unit (c)) contained in the acrylic resin (1) or the acrylic resin (2) is usually approximately 100 parts by weight or less based on 100 parts by weight of the acrylic resin. When containing the structural unit (c), even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

In producing the acrylic resin (1) and the acrylic resin (2) used in the present invention, a vinyl-based monomer (d) may be polymerized.

The vinyl-based monomer (d) is different from the monomers (a) to (c) and has at least one vinyl group in the molecule include fatty vinyl esters, halogenated vinyls, halogenated vinylidenes, aromatic vinyls, (meth)acrylonitrile, conjugated diene compounds and the like.

Examples of the fatty vinyl ester include vinyl acetate, vinyl propionate, vinyl butyrate, vinyl 2-ethylhexanoate, vinyl laurate and the like.

Examples of the halogenated vinyl include vinyl chloride, vinyl bromide and the like.

Examples of the halogenated vinylidene include vinylidene chloride and the like.

The aromatic vinyl is a compound having a vinyl group and an aromatic group, and specific examples thereof include styrene-based monomers such as styrene, methylstyrene, dimethylstyrene, trimethylstyrene, ethylstyrene, diethylstyrene, triethylstyrene, propylstyrene, butylstyrene, hexylstyrene, heptylstyrene, octylstyrene, fluorostyrene, chlorostyrene, bromostyrene, dibromostyrene, iodostyrene, nitrostyrene, acetylstyrene, methoxystyrene, divinylstyrene and the like, nitrogen-containing aromatic vinyls such as vinylpyridine, vinyl carbazole and the like, divinyl esters such as divinyl adipate, divinyl sebacate and the like.

The conjugated diene compound is an olefine having a conjugated double bond in the molecule, and specific examples thereof include isoprene, butadiene, chloroprene and the like.

The vinyl-based monomer (d) may be used alone or in combination of two or more.

The content of the structural unit (d) derived from the monomer (d) contained in the acrylic resin (1) or the acrylic resin (2) is usually 5 parts by weight or less, preferably 0.05 parts by weight or less based on 100 parts by weight of all structural units constituting the acrylic resin, and it is more preferable that the structural unit (d) is not substantially contained.

In producing the acrylic resin (1) and the acrylic resin (2) used in the present invention, a monomer (e) may be polymerized.

The monomer (e) is different from the monomers (a) to (d) and has plural olefinic double bonds in the molecule.

Examples of the monomer (e) include (meth)acrylates such as ethylene glycol di(meth)acrylate, diethylene glycol di(meth)acrylate, 1,3,5-triacrylolylhexahydro-S-triazine, tetramethylolmethane tetraacrylate; bis(meth)acrylates such as methylenebis(meth)acrylamide, ethylenebis(meth)acrylamide, N,N-diallylacrylamide; allyl(meth)acrylate, triallylisocyanurate, triallylamine, tetraallylpyromellitate, N,N,N,N-tetraallyl-1,4-diaminobutane, tetraallyl ammonium salt, and the like.

The vinyl-based monomer (e) may be used alone or in combination of two or more.

The content of the structural unit (e) derived from the monomer (e) contained in the acrylic resin (1) or the acrylic resin (2) is usually 5 parts by weight or less, preferably 0.05 parts by weight or less based on 100 parts by weight of all structural units constituting the acrylic resin, and it is more preferable that the structural unit (e) is not substantially contained.

As the method of producing the acrylic resin (1) used in the present invention, for example, a solution polymerization method, emulsion polymerization method, block polymerization method, suspension polymerization method and the like are listed.

In production of an acrylic resin, a polymerization initiator is usually used. The polymerization initiator is usually used in an amount of approximately 0.1 to 5 parts by weight based on 100 parts by weight of all monomers used in production of the acrylic resin.

As the polymerization initiator, for example, a heat-polymerization initiator, photo-polymerization initiator, and the like are listed.

Examples of the heat-polymerization initiator include azo-based compounds such as 2,2′-azobisisobutyronitrile, 2,2′-azobis(2-methylbutyronitrile), 1,1′-azobis(cyclohexane-1-carbonitrile), 2,2′-azobis(2,4-dimethylvaleronitrile), 2,2′-azobis(2,4-dimethyl-4-methoxyvaletonitrile), dimethyl-2,2′-azobis(2-methylpropionate), 2,2′-azobis(2-hydroxymethylpropionitrile) and the like; organic peroxides such as lauryl peroxide, tert-butyl hydroperoxide, benzoyl peroxide, tert-butyl peroxybenzoate, cumene hydroperoxide, diisopropyl peroxy dicarbonate, di-n-propyl peroxydicarbonate, tert-butyl peroxyneodecanoate, tert-butyl peroxypivalate, (3,5,5-trimethylhexanonyl) peroxide and the like;
inorganic peroxides such as potassium persulfate, ammonium persulfate, hydrogen peroxide and the like.

Examples of the photo-polymerization initiator include 4-(2-hydroxyethoxy)phenyl(2-hydroxy-2-propyl)ketone and the like.

Redox-based initiators using a heat-polymerization initiator and a reducing agent together can also be used as a polymerization initiator.

As the method of producing an acrylic resin (1), a solution polymerization method is preferable.

Specifically mentioned as the solution polymerization method are a method in which given monomers and an organic solvent are mixed, a heat-polymerization initiator is added under a nitrogen atmosphere, and the mixture is stirred for approximately 3 to 10 hours at approximately 40 to 90° C., preferably approximately 60 to 80° C., and other methods. For controlling the reaction, a method in which monomers and a heat-polymerization initiator used are added during polymerization, a method in which these are dissolved in an organic solvent before addition thereof, and the like may be adopted.

Here, examples of the organic solvent include aromatic hydrocarbons such as toluene, xylene and the like; esters such as ethyl acetate, butyl acetate and the like; aliphatic alcohols such as n-propyl alcohol, isopropyl alcohol and the like; ketones such as methyl ethyl ketone, methyl isobutyl ketone and the like.

The weight-average molecular weight based on polystyrene calibration standard of gel permeation chromatography (GPC) of the acrylic resin (1) is usually 50,000-500,000. When the weight-average molecular weight is 50,000 or more, adhesion under high temperature and high humidity increases, and floating and peeling between a glass base plate and an adhesive layer tends to lower, further, a re-working property tends to be improved, preferably. When the weight-average molecular weight is 500,000 or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

As the method of producing the acrylic resin (2) used in the present invention, for example, a solution polymerization method, emulsion polymerization method, block polymerization method, suspension polymerization method and the like are listed. Among them, a solution polymerization method is preferable.

Specifically mentioned as the solution polymerization method are a method in which given monomers and an organic solvent are mixed to obtain a mixture having a monomer concentration of usually 50% by weight or more, preferably 50 to 60% by weight, approximately 0.001 to 0.1 part by weight of a heat-polymerization initiator is added under a nitrogen atmosphere, and the mixture is stirred for usually 8 hours or more, preferably approximately 8 to 12 hours at approximately 40 to 90° C., preferably approximately 50 to 70° C., and other methods.

As a heat-polymerization initiator in producing the acrylic resin (2), the same heat-polymerization initiator in producing the acrylic resin (1) can be used. As the organic solvent, the same organic solvent in producing the acrylic resin (1) can be used.

The weight-average molecular weight based on polystyrene calibration standard of gel permeation chromatography (GPC) of the acrylic resin (2) is usually 1,000,000-1,500,000. When the weight-average molecular weight is 1,000,000 or more, adhesion under high temperature and high humidity increases, and floating and peeling between a glass base plate and an adhesive layer tends to lower, further, a re-working property tends to be improved, preferably. When the weight-average molecular weight is 1,500,000 or less, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably.

The molecular weight distribution (weight-average molecular weight/number-average molecular weight (Mw/Mn)) of the acrylic resin (2) is usually 5 or less, preferably 3 to 4. When the molecular weight distribution is 5 or less, cohesive force tends to be improved while keeping flexibility to some extent.

A glass transition temperature (Tg) of the acrylic resin (1) is usually approximately −30° C. to −5° C. When Tg is −30° C. or more, adhesion under high temperature and high humidity increases, and floating and peeling between a glass base plate and an adhesive layer tends to lower, preferably. When Tg is −5° C. or less, even if the dimension of an optical film changes, an adhesive layer varies following this dimension change, consequently, a difference between brightness of peripheral parts of a liquid crystal cell and brightness of central parts become smaller, and light leakage and non-uniformity of color tend to be suppressed preferably.

A glass transition temperature (Tg) of the acrylic resin (2) is not limited, but is preferably 0° C. or less.

A glass transition temperature (Tg) in the present specification is calculated according to Fox formula (see, Kobunshi Kagaku Jyoron 2^{nd}. Edition, page 172).

Regarding the weight ratio (non-volatile component) of the acrylic resin (1) and the acrylic resin (2) used in the adhesive of the present invention, the acrylic resin (1) is usually 10-50 parts by weight, preferably approximately 20 to 40 parts by weight based on 100 parts by weight of the total amount of the acrylic resin (1) and acrylic resin (2). When the ratio of the acrylic resin (1) is 10 parts by weight or more, even if the dimension of an optical film changes, an adhesive layer varies following this dimension change, consequently, a difference between brightness of peripheral parts of a liquid crystal cell and brightness of central parts becomes smaller, and light leakage and non-uniformity of color tend to be suppressed preferably. When the ratio of the acrylic resin (1) is 50 parts by weight or less, adhesion under high temperature and high humidity increases, and floating and peeling between a glass base plate and an adhesive layer tends to lower, further, a re-working property tends to be improved, preferably.

The adhesive of the present invention is the adhesive obtained by compounding a cross-linking agent to the acrylic resin composition containing the acrylic resin (1), the acrylic resin (2) and a silane-based compound.

The gel fraction of the adhesive compounding a cross-linking agent is usually 10 to 50% by weight.

Here, the gel fraction means a value measured according to the following (I) to (IV).

(I) An adhesive layer (thickness: 25 μm) having an area of approximately 8 cm×approximately 8 cm and, a metal mesh of SUS (stainless steel) 304 mesh (approximately 10 cm×approximately 10 cm, weight (Wm)) are pasted.

(II) The weight (Ws) of the pasted article obtained in (I) was measured, and the article is folded four times so as to wrap the adhesive layer and fastened by a stapler, then, weighed (Wb).

(III) The mesh obtained in (II) is charged in a 125 ml glass vessel, and 60 ml of ethyl acetate is added for immersion, then, this glass vessel is stored at room temperature for 3 days.

(IV) The mesh is removed out from the glass vessel, dried at 120° C. for 24 hours, then, weighed (Wa), and the gel fraction is calculated based on the following formula.
Gel fraction (wt %)={Wa−(Wb−Ws)−Wm/(Ws−Wm)}×100

In the adhesive of the present invention, a functional group contained in the structural unit (b) and a cross-linking agent are reacted to be gel. Therefore, in order to increase the gel fraction, a content of a cross-linking agent may be increased preferably.

The cross-linking agent used in the adhesive of the present invention has in the molecule two or more functional groups capable of cross-linking with a polar functional group contained in the acrylic resin (2), and specific examples thereof include isocyanate-based compounds, epoxy-based compounds, metal chelate-based compounds, aziridine-based compounds and the like.

Here, examples of the isocyanate-based compound include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polymethylene polyphenyl isocyanate and the like, and adducts obtained by reacting polyols such as glycerol, trimethylolpropane and the like with the above-mentioned isocyanate compounds, and those obtained by converting the isocyanate compounds into dimmers, trimers and the like, are also included.

Examples of the epoxy-based compound include bisphenol A type epoxy resin, ethylene glycol glycidyl ether, polyethylene glycol diglycidyl ether, glycerine glycidyl ether, glycerine triglycidyl ether, 1,6-hexanediol diglycidyl ether, trimethylolpropane triglycidyl ether, diglycidylaniline, N,N,N′,N′-tetraglycidyl-m-xylenediamine, 1,3-bis(N,N′-diglycidylaminomethyl)cyclohexane and the like.

Examples of the metal chelate compound include compounds obtained by coordinating acetylacetone or ethyl acetoacetate on poly-valent metals such as aluminum, iron, copper, zinc, tin, titanium, nickel, antimony, magnesium, vanadium, chromium, zirconium and the like.

Examples of the aziridine-based compound include N,N′-diphenylmethane-4,4′-bis(1-aziridine carboxide), N,N′-toluene-2,4-bis(1-aziridine carboxamide), triethylenemelamine, bisisophthaloyl-1-(2-methylaziridine), tri-1-aziridinylphosphine oxide, N,N′-hexamethylene-1,6-bis(1-aziridine carboxide), trimethylolpropane-tri-β-aziridinyl propionate, tetramethylolmethane-tri-β-aziridinyl propionate, and the like.

The cross-linking agent may be used alone or in combination of two or more. The use amount of a cross-linking agent (non-volatile component) in the adhesive is usually from approximately 0.005 to 5 parts by weight, preferably from approximately 0.01 to 3 parts by weight based on 100 parts by weight of an acrylic resin (non-volatile component). When the amount of the cross-linking agent is 0.005 parts by weight or more, floating and peeling between a glass base plate and an adhesive layer and a re-working property tend to be improved preferably, and when 5 parts by weight or less, a property of an adhesive layer to follow the dimension change of an optical film is excellent, consequently, light leakage and non-uniformity of color tend to lower preferably.

Examples of the silane-based compound used in the adhesive of the present invention include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, 3-glycidoxypropyltriethoxysilane, 3-glycidoxypropyldimethoxymethylsilane, 3-glycidoxypropylethoxydimethylsilane and the like. In the adhesive of the present invention, two or more silane-based compounds may be used.

The use amount of the silane-based compound (solution) is usually from approximately 0.0001 to 10 parts by weight, preferably from 0.01 to 5 parts by weight based on 100 parts by weight of an acrylic resin (non-volatile component). When the amount of a silane-based compound is 0.0001 part by weight or more, adhesion between an adhesive layer and a glass base plate is improved preferably. When the amount of a silane-based compound is 10 parts by weight or less, bleeding out of a silane-based compound from the adhesive layer tends to be suppressed preferably.

The adhesive of the present invention is composed of an acrylic resin, cross-linking agent and/or silane-based compound as described above, and, a cross-linking catalyst, weather-resistant stabilizer, tackifier, plasticizer, softening agent, dye, pigment, inorganic filler and the like may be further compounded to the adhesive of the present invention.

The optical laminated film can be produced in comparatively short time by compounding a cross-linking catalyst together with a cross-linking agent to the adhesive. In the optical laminate containing the optical laminated film, floating and peeling between an optical film and an adhesive layer, and foaming in the adhesive layer tend to lower, further, a re-working property tends to be improved, preferably.

Examples of the cross-linking catalyst include amine-based compound such as hexamethylenediamine, ethylenediamine, polyethyleneimine, hexamethylenetetramine, diethylenetriamine, triethylenetetramine, isophoronediamine, triethylenediamine, polyamino resin, melamine resin, and the like. When using the amine-based compound as the cross-linking catalyst in the adhesive, the isocyanate-based compound is preferably used as the cross-linking agent.

The optical laminated film of the present invention is obtained by laminating an adhesive layer composed of the above-mentioned adhesive on an optical film.

As the method for producing an optical laminated film, there are listed, for example, a method in which an adhesive diluted with an organic solvent is applied on a release film and usually heated at 60-120° C. for approximately 0.5-10 minutes to distill off the organic solvent to obtain the adhesive layer. Subsequently, an optical film is further laminated on the resulted adhesive layer, then, aged under a temperature of 23° C. and a humidity of 65% for approximately 5-20 days, after a cross-linking agent is fully reacted, the release film is peeled to obtain an optical laminated film;

a method in which the adhesive layer is obtained as the same manner in the above-mentioned method, two layer laminate composed of the resulted adhesive layer and a release film is combined so that the adhesive layer and the release film are layered alternatively to obtain a multi-layer laminate, then, aged under a temperature of 23° C. and a humidity of 65% for approximately 5-20 days, after a cross-linking agent is fully reacted, the release film is peeled, and an optical film instead of the release film is laminated to obtain an optical laminated film; and the like.

Here, the release film is the base material in forming the adhesive layer. When aging and preserving as the optical laminated film, the release film is used as the base material for protecting the adhesive layer from dust and the like.

As the release film, there are mentioned, for example, those obtained by using as a base material a film composed of various resins such as polyethylene terephthalate, polybutylene terephthalate, polycarbonate, polyallylate and the like, and performing releasing treatment (silicone treatment and the like) on a surface to be connected to an adhesive layer of this base material.

Here, the optical film is a film having an optical property, and examples thereof include a polarizing film, phase retardation film and the like.

The polarizing film is an optical film having a function of emitting polarization against incidence light such as natural light and the like.

Examples of the polarizing film include a straight line polarizing film absorbing straight line polarization on a vibration place parallel to an optical axis and allowing permeation of straight light polarization having a vibration plane which is a vertical plane, a polarizing separation film reflecting straight line polarization on a vibration plane parallel to an optical axis, an elliptic polarizing film obtained by laminating a polarizing film and a phase retardation film described later. As the specific examples of the polarizing film, those in which dichroic coloring matters such as iodine, dichroic dyes and the like are adsorbed and oriented in a mono-axially stretched polyvinyl alcohol film, and the like are listed.

The phase retardation film is an optical film having mono-axial or bi-axial optical anisotropy, and listed are stretched films obtained by stretching at approximately 1.01 to 6-fold a polymer film composed of polyvinyl alcohol, polycarbonate, polyester, polyallylate, polyimide, polyolefin, polystyrene, polysulfone, polyether sulfone, polyvinylidene fluoride/polymethyl methacryalte, liquid crystal polyester, acetylcellulose, cyclic polyolefin, ethylene-vinyl acetate copolymer saponified material, polyvinyl chloride and the like. Among them, polymer films obtained by mono-axial or bi-axial stretching of polycarbonate or polyvinyl alcohol are preferably used.

Examples of the phase retardation film include a mono-axial phase retardation film, wide viewing angle phase retardation film, low photo-elastic phase retardation film, temperature-compensated phase retardation film, LC film (rod-like liquid crystal twisted orientation), WV film (disc-like liquid crystal inclined orientation), NH film (rod-like liquid crystal inclined orientation), VAC film (complete bi-axial orientation type phase retardation film), new VAC film (bi-axial orientation type phase retardation film) and the like.

On both surfaces or one surface of the above-mentioned optical film, a protective film may be further applied. Examples of the protective film include films composed of acrylic resins different from the acrylic resin of the present invention, acetylcellulose-based films such as a cellulose triacetate film and the like, polyester resin films, olefin resin films, polycarbonate resin films, polyether ketone resin films, polysulfone resin films and the like.

In the protective film, ultraviolet absorbers such as a salicylate-based compound, benzophenone-based compound, benzotriazole-based compound, triazine-based compound, cyanoacrylate-based compound, nickel complex salt-based compound and the like may be compounded. In the protective films, acetylcellulosed-based films are suitably used.

The optical laminate of the present invention contains the optical laminated film and a glass base plate. The optical laminate of the present invention is usually obtained by laminating a glass base plate on an adhesive layer of an optical laminated film.

Here, examples of the glass base plate include a glass base plate of liquid crystal cell, non-glaring glass, glass for sunglasses, and the like. Among them, an optical laminate obtained by laminating an optical laminated film (upper plate polarization plate) on a upper glass base plate of a liquid crystal cell, and laminating another optical laminated film (lower plate polarization plate) on a lower glass base plate of a liquid crystal cell is preferable since it can be used as a liquid crystal display. As the material of a glass base plate, for example, soda lime glass, low-alkali glass, non-alkali glass and the like are listed.

The adhesive of the present invention is excellent in flexibility and showing excellent adhesion with an optical film and the like.

The optical laminated film laminating the adhesive and an optical film can be laminated on a glass base plate of a liquid crystal cell to produce an optical laminate of the present invention.

In such an optical laminate, the adhesive layer absorbs and relaxes stress derived from the dimension change of the optical film and glass base plate under heat and humidity conditions, therefore, local stress concentration is decreased, and floating and peeling of the adhesive layer from the glass base plate is suppressed. Further, since optical defects caused by non-uniform stress distribution are prevented, when the glass base plate is a TN liquid crystal cell (TNT), light leakage is suppressed.

Even after peeling of the optical laminated film from the optical laminate in order to re-laminate the optical laminated film, fogging and paste remaining and the like scarcely occur on the surface of a glass base material in contact with an adhesive layer, a so-called re-working property is excellent. Therefore, even after peeling of the optical laminated film from the glass base material of the optical laminate, fogging and paste remaining and the like scarcely occur on the surface of a glass base material, so it is easy to apply an optical laminated film again on the peeled glass base plate.

The adhesive of the present invention can be used, for example, as an adhesive suitable for an optical laminate such as a TN liquid crystal cell (TFT) and the like.

When using the adhesive of the present invention for STN liquid crystal cell, non-uniformity color of the obtained optical laminate can be suppressed.

### EXAMPLES

The present invention will be described further in detail based on examples, but it is needless to say that the scope of the invention is not limited to these examples at all.

In the examples, parts and % are by weight unless otherwise stated.

The content of non-volatile components was measured according to JIS K-5407. Specifically, an optional weight of adhesive solution was placed on a Petri dish, and dried in an explosion protection oven at 115° C. for 2 hours, then, the weight of remaining non-volatile components was divided by the weight of the originally weighed solution.

The viscosity is a value measured by a Brook field viscometer at 25° C.

Measurement of the weight-average molecular weight based on polystyrene calibration standard by GPC was conducted using a GPC apparatus equipped with a differential refractometer as a detector and two columns of TSKgel G6000H_{XL} and two columns of TSKgel G5000H_{XL} serially connected as a column, under conditions of a sample concentration of 5 mg/ml, a sample introduction amount of 100 μl, a column temperature of 40° C. and a flow rate of 1 ml/min, and using tetrahydrofuran as an eluent.

<Production Example of Acrylic Resin>

### Polymerization Example 1

Into a reactor equipped with a cooling tube, nitrogen introduction tube, thermometer and stirrer was charged 222 parts of ethyl acetate, air in the apparatus was purged with a nitrogen gas to make no-oxygen atmosphere, then, the inner temperature was raised to 75° C. 0.55 parts of azobisisobutyronitrile (hereinafter, referred to as AIBN) was dissolved in 12.5 parts of ethyl acetate and the prepared solution was all added to the reactor, while keeping inner temperature at 69-71° C., then, a mixed solution of 36 parts of butyl acrylate, 44 parts of butyl methacrylate and 20 parts of methyl acrylate as a monomer (a) was dropped into the reaction system over 3 hours. Thereafter, the reaction was completed while the inner temperature is keeping at 69 to 71° C. for 5 hours. The weight-average molecular weight based on polystyrene calibration standard by GPC was 100,000 and Tg was −13° C. The results were shown in Table 1.

### Polymerization Example 2

The reaction was completed in the same manner as in Polymerization Example 1 except that 35 parts of butyl acrylate; and 1 part of hydroxyethyl acrylate as a monomer (b) were used. The weight-average molecular weight based on polystyrene calibration standard by GPC was 90,000 and Tg was −13° C. The results were shown in Table 1.

### Polymerization Example 3

Into a reactor equipped with a cooling tube, nitrogen introduction tube, thermometer and stirrer was charged a mixed solution of 100 parts of ethyl acetate; 98.9 parts of butyl acrylate as a monomer (a); and 1.1 parts of acrylic acid as a monomer (b), air in the apparatus was purged with a nitrogen gas to make no-oxygen atmosphere, then, the inner temperature was raised to 70° C. 0.03 parts of azobisisobutyronitrile (hereinafter, referred to as AIBN) was dissolved in 10 parts of ethyl acetate and the prepared solution was all added to the reactor. Thereafter, the reaction was completed while the inner temperature is keeping at 69 to 71° C. for 12 hours. The weight-average molecular weight based on polystyrene calibration standard by GPC was 1,200,000 and Mw/Mn was 3.9.

### Polymerization Example 4

Into a reactor equipped with a cooling tube, nitrogen introduction tube, thermometer and stirrer was charged a mixed solution of 99 parts of butyl acrylate as a monomer (a) and 1.0 part of acrylic acid as a monomer (b), air in the apparatus was purged with a nitrogen gas to make no-oxygen atmosphere, then, the inner temperature was raised to 65° C. 0.2 parts of azobisisobutyronitrile (hereinafter, referred to as AIBN) was dissolved in 10 parts of ethyl acetate and the prepared solution was all added to the reactor. Thereafter, the inner temperature is keeping at 65° C., and then 0.4 parts of AIBN was dissolved in 20 parts of ethyl acetate and the prepared solution was added to the reactor over 1 hour and the reaction was completed for 2 hours. The weight-average molecular weight based on polystyrene calibration standard by GPC was 1,050,000 and Mw/Mn was 10.0.

### Example 1

<Production Example of Adhesive>

Ethyl acetate solution of the acrylic resin was obtained by mixing the acrylic resin (1) and the acrylic resin (2) at the ratio illustrated in Table 1. To 100 parts of non-volatile components in the resulted solution was mixed 0.07 part of non-volatile components of a polyisocyanate-based compound (trade name: Takenate D-160N, manufactured by Mitsui-Takeda Chemical Inc.) and 0.1 part of a silane-based compound (trade name: Y11597, manufactured by Dow Corning Toray Silicone Co. Ltd.) as a cross-linking agent, to obtain an adhesive of the present invention.

<Production Examples of Optical Laminated Film and Optical Laminate>

Thus obtained adhesive was applied, using an applicator, on a releasing-treated surface of a polyethylene terephthalate film (manufactured by LINTEC Corporation, trade name: PET 3811) which had been subjected to releasing treatment so that the thickness after drying was 25 μm, the dried at 90° C. for 1 minute, to obtain an adhesive in the form of sheet. Then, a polarizing film (film having a three-layer structure obtained by adsorbing iodine into polyvinyl alcohol and stretching to obtain a stretched film and sandwiching said stretched film on both surfaces thereof by triacetylcellulose-based protective films) was used as an optical film, and a surface having the adhesive obtained above was applied on this optical film by a laminator, then, aged under a temperature of 23° C. and a humidity of 65% for 10 days, to obtain an optical laminated film having an adhesive layer. Subsequently, this optical laminated film was adhered on both surfaces of a glass base plate for liquid crystal cell (manufactured by Corning, 1737) so as to give Cross Nicol condition. This was preserved under 80° C. and dry condition for 96 hours (condition 1), 60° C. and 90% RH for 96 hours (condition 2), 100 cycles of 60° C.→−20° C.→60° C. as one cycle (condition 3), and durability (condition 1-3) and light leakage (condition 1) of the optical laminate after preservation were observed visually. The results are classified as described below and shown in Table 1.

<Light Leakage Property of Optical Laminate>

Evaluation of state of generation of light leakage was conducted according to the following four stages.
⊚: no light leakage
◯: little light leakage
Δ: slight light leakage
X: remarkable light leakage
   <Durability of Optical Laminate>

Evaluation of durability was conducted according to the following four stages.
⊚: no change in appearance such as floating, peeling, foaming and the like
◯: little change in appearance such as floating, peeling, foaming and the like
Δ: slight change in appearance such as floating, peeling, foaming and the like
X: remarkable change in appearance such as floating, peeling, foaming and the like
   <Re-Working Property>

Evaluation of the re-working property was conducted as described below. First, the above-mentioned optical laminate was processed into a specimen of 25 mm×150 mm. Then, this specimen was pasted on a glass base plate for liquid crystal display (manufactured by Corning, 1737) using a pasting apparatus (“Lamipacker”, manufactured by Fuji Plastic Machine K.K.), and treated in an autoclave under 50° C., 5 kg/cm² (490.3 kPa) for 20 minutes, subsequently, heated in an oven under 70° C. for 2 hours, preserved in an oven under 50° C. for 48 hours. The optical laminate for peeling test was peeled toward 180° direction at a rate of 300 mm/min in an atmosphere of 23° C. and 50% RH, and the state of the surface of the glass plate classified according to the following conditions was observed and shown in Table 1.

Evaluation of the re-working property was conducted by observing the state of the surface of the glass plate according to the following four stages.
⊚: no fogging and past remaining on the surface of glass plate
◯: little fogging and the like on the surface of glass plate
Δ: fogging and the like on the surface of glass plate
X: paste remaining on the surface of glass plate

### Examples 2 to 3 and Comparative Examples 1 to 4

An acrylic resin (composition), adhesive, optical laminated film and optical laminate were produced according to Example 1 using the acrylic resins (1) and (2) at weight ratios shown in Table 1. Evaluation of the resulted optical laminate was conducted in the same manner as in Example 1, and the results are shown in Table 1 together with that of Example 1.

TABLE 1

| | | Example | | | Comparative Example | | | |
|---|---|---|---|---|---|---|---|---|
| | | 1 | 2 | 3 | 1 | 2 | 3 | 4 |
| Acrylic | Polymerization example | 1 | 2 | 2 | 1 | 1 | 2 | 1 |
| resin (1) | Non-volatile component | 30 | 30 | 30 | 5 | 30 | 30 | 30 |
| | content (part by weight) | | | | | | | |
| | (a)*¹ | 100 | 99 | 99 | 100 | 100 | 99 | 100 |
| | (part by weight) | | | | | | | |
| | (b)*² | 0 | 1 | 1 | 0 | 0 | 1 | 0 |
| | (part by weight) | | | | | | | |
| Acrylic | Polymerization example | 3 | 3 | 3 | 3 | 4 | 4 | 4 |
| resin | Non-volatile component | 70 | 70 | 70 | 95 | 70 | 70 | 70 |
| (2)*³ | content (part by weight) | | | | | | | |
| | (a)*¹ | 98.9 | 98.9 | 98.9 | 98.9 | 99 | 99 | 99 |
| | (part by weight) | | | | | | | |
| | (b)*² | 1.1 | 1.1 | 1.1 | 1.1 | 1 | 1 | 1 |
| | (part by weight) | | | | | | | |
| Cross- | kind | D-160N | D-160N | D-160N | D-160N | D-160N | D-160N | D-160N |
| linking | part by weight | 0.1 | 0.1 | 0.07 | 0.05 | 0.5 | 0.5 | 1.25 |
| agent | | | | | | | | |
| Silane | kind | KBM 803 | KBM 803 | Y 11597 | KBM 803 | KBM 803 | KBM 803 | KBM 803 |
| com- | part by weight | 0.4 | 0.4 | 0.1 | 0.4 | 0.4 | 0.4 | 0.4 |
| pound | | | | | | | | |
| Condi- | Durability | ⊚ | ⊚ | ⊚ | ◯ | ◯ | ◯ | ◯ |
| tion 1 | Light leakage property | ⊚ | ⊚ | ⊚ | ◯ | ◯ | ◯ | X |
| Condi- | Durability | ⊚ | ◯ | ◯ | Δ | ◯ | ◯ | ◯ |
| tion 2 | | | | | | | | |
| Condi- | Durability | ◯ | ⊚ | ⊚ | Δ | X | X | X |
| tion 3 | | | | | | | | |
| Re- | Paste remaining property | ⊚ | ◯ | ◯ | ◯ | ⊚ | ◯ | ⊚ |
| working | | | | | | | | |
| property | | | | | | | | |
| Gel | % | 30 | 30 | 19 | 40 | 35 | 33 | 67 |
| fraction | | | | | | | | |

*¹Parts by weight of structural unit (a) based on 100 parts by weight of acrylic resin (1) or (2).
*²Parts by weight of structural unit (b) based on 100 parts by weight of acrylic resin (1) or (2).

What is claimed is:

1. An adhesive obtained by compounding a cross-linking agent to an acrylic resin composition comprising a silane-based compound and the following acrylic resins (1) and (2), wherein the content of acrylic resin (1) is 10 to 50 parts by weight based on 100 parts by weight of the total amount of the acrylic resin (1) and acrylic resin (2);
acrylic resin (1): an acrylic resin having a molecular weight of 50,000 to 500,000 and containing a structural unit derived from a monomer (a) (structural unit (a));
acrylic resin (2): an acrylic resin having a molecular weight of 1,000,000 to 1,500,000 and a molecular weight distribution (Mw/Mn) of 5 or less, and containing the structural unit (a) as the main component and a structural unit derived from a monomer (b) (structural unit (b));
(a): a (meth)acrylate of the formula (A) 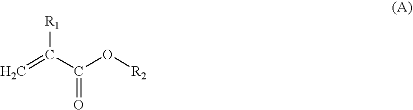
(wherein, R₁ represents a hydrogen atom or methyl group, R₂ represents an alkyl group having 1 to 14 carbon atoms or an aralkyl group having 1 to 14 carbon atoms, and a hydrogen atom in the alkyl group R₂ or a hydrogen atom in the aralkyl group R₂ may be substituted with an alkoxy group having 1 to 10 carbon atoms.),
(b): a monomer containing one olefinic double bond and at least one polar functional group selected from the group consisting of a carboxyl group, hydroxyl group, amide group, amino group, epoxy group, oxetanyl group, aldehyde group and isocyanate group in the molecule.

2. The adhesive according to claim 1, wherein the glass transition temperature (Tg) of the acrylic resin (1) is from −30° C. to −5° C.

3. The adhesive according to claim 1, wherein the acrylic resin (1) further contains the structural unit (b).

4. The adhesive according to claim 1, wherein the content of the structural unit (b) in the acrylic resin (2) is from 0.5 to 2 parts by weight based on 100 parts by weight of the acrylic resin (2).

5. An optical laminated film laminating an adhesive layer composed of the adhesive according to claim 1 on both surfaces or one surface of an optical film.

6. The optical laminated film according to claim 5, wherein the optical film is a polarizing film and/or phase retardation film.

7. The optical laminated film according to claim 5, wherein the optical film further has an acetylcellulose-based film as a release film.

8. The optical laminated film according to claim 5, wherein a release film is further laminated on the adhesive layer of the optical laminated film.

9. An optical laminate obtained by laminating a glass base material on the adhesive layer of the optical laminated film according to claim 5.

10. An optical laminate obtained by peeling the release film from the optical laminated film according to claim 8, then, laminating a glass base material on the adhesive layer of the optical laminated film.

11. An optical laminate obtained by peeling the optical laminated film from the optical laminate according to claim 9, then, laminating again the optical laminated film on the resulted glass base material.
